(19) United States
(12) Patent Application Publication
(10) Pub. No.: US 2018/0260795 A1
(43) Pub. Date: Sep. 13, 2018

(54) METHOD AND SYSTEM FOR ACCESSING LOCALLY STORED DIGITAL FUNDS

(71) Applicant: Mastercard International Incorporated, Purchase, NY (US)

(72) Inventors: Pia MAENPAA, White Plains, NY (US); Manish KUMAR, Gurgaon (IN); Nishant MAHESHWARI, Delhi (IN); Ankur ARORA, Jasola (IN)

(73) Assignee: Mastercard International Incorporated, Purchase, NY (US)

(21) Appl. No.: 15/457,007

(22) Filed: Mar. 13, 2017

(51) Int. Cl. G06Q 20/06; H04L 9/32

(52) U.S. Cl. CPC G06Q 20/0658; H04L 9/3263

(57) ABSTRACT

A method for processing an offline transaction using local digital currency includes: receiving, by a receiving device of a payment instrument, a funding notification, the notification including a currency limit and associated transaction data; storing, in a memory of a payment instrument, the currency limit and associated transaction data; receiving, by the receiving device of the payment instrument, a transaction request for a payment transaction from a point of sale device, the request including at least a transaction amount; electronically transmitting, by a transmitting device of the payment instrument, a transaction response to the point of sale device, the response including an indication of approval and at least a portion of the associated transaction data; and executing, by a querying module of the payment instrument, a query on the memory of the payment instrument to update the currency limit based on the transaction amount.

### FIELD

The present disclosure relates to the processing of offline transactions using local digital currency, specifically the storage of local data on a payment instrument that can be used in the offline processing of an electronic transaction processed entirely via a point of sale without the use of an external payment network.

### BACKGROUND

For many consumers, credit cards, smart phones, and other alternative payment instruments have replaced cash for a majority of their transactions. In many cases, credit cards and such alternative payment instruments provides a consumer with greater convenience, security, record keeping, and rewards for each of their transactions instead of using cash. However, there may be times where the use of traditional alternative payment instruments may be unavailable. For instance, a merchant may lack an active connection to a payment network that is used to process transactions, which are required for traditional alternative payment instruments.

In such cases, the lack of an active (e.g., “online”) connection to a payment network may result in the merchant being unable to conduct payment transactions unless paid for with cash. As a result, the merchant may lose out on potential transactions with consumers that do not carry cash or do not have sufficient cash for their desired purchases. In addition, consumers that may be interested in transacting may find themselves unable to pay, to their detriment. These problems pose technical problems in how to improve the technology behind these types of transactions.

Thus, there is a need for a technical solution that can enable the processing of a payment transaction at a point of sale offline, without the use of a connection to a traditional payment network.

### SUMMARY

The present disclosure provides a description of systems and methods for the processing of an offline transaction using local digital currency. A payment instrument is used to store digital funds or a credit limit associated with a related transaction account locally in memory of the payment instrument. The payment instrument can, using this local information, convey necessary information to a point of sale, such as the account having a sufficient balance or there being sufficient local funds to pay for a transaction without online processing. The result may be the ability for a consumer to use their preferred payment instrument at a point of sale, even for use in funding transactions when there is not an available connection to the related processing network.

A method for processing an offline transaction using local digital currency includes: receiving, by a receiving device of a payment instrument, a funding notification, wherein the funding notification includes a currency limit and associated transaction data; storing, in a memory of a payment instrument, the currency limit and associated transaction data; receiving, by the receiving device of the payment instrument, a transaction request for a payment transaction from a point of sale device, wherein the transaction request includes at least a transaction amount; electronically transmitting, by a transmitting device of the payment instrument, a transaction response to the point of sale device, wherein the transaction response includes an indication of approval and at least a portion of the associated transaction data; and executing, by a querying module of the payment instrument, a query on the memory of the payment instrument to update the currency limit based on the transaction amount.

Another method for processing an offline transaction using local digital currency includes: receiving, by a receiving device of a point of sale device, a transaction notification for a payment transaction including at least an indication of a request for a local digital currency transaction; electronically transmitting, by a transmitting device of the point of sale device, a transaction request to a payment instrument, wherein the transaction request includes at least a transaction amount; receiving, by the receiving device of the point of sale device, a transaction response from the payment instrument, wherein the transaction response includes at least an indication of approval and transaction data associated with the transaction amount; verifying, by a verification module of the point of sale device, the transaction data included in the received transaction response; and storing, in a memory of the point of sale device, the verified transaction data.

A system for processing an offline transaction using local digital currency includes: a transmitting device of a payment instrument; a querying module of the payment instrument; a receiving device of the payment instrument, a funding notification, wherein the funding notification includes a currency limit and associated transaction data; and a memory of a payment instrument configured to store the currency limit and associated transaction data, wherein the receiving device of the payment instrument is further configured to receive a transaction request for a payment transaction from a point of sale device, wherein the transaction request includes at least a transaction amount, the transmitting device of the payment instrument is configured to electronically transmit a transaction response to the point of sale device, wherein the transaction response includes an indication of approval and at least a portion of the associated transaction data, and the querying module of the payment instrument is configured to execute a query on the memory of the payment instrument to update the currency limit based on the transaction amount.

Another system for processing an offline transaction using local digital currency includes: a memory of a payment instrument; a verification module of the payment instrument; a receiving device of the payment instrument configured to receive a transaction notification for a payment transaction including at least an indication of a request for a local digital currency transaction; and a transmitting device of the point of sale device configured to electronically transmit a transaction request to a payment instrument, wherein the transaction request includes at least a transaction amount, wherein the receiving device of the point of sale device is further configured to receive a transaction response from the payment instrument, wherein the transaction response includes at least an indication of approval and transaction data associated with the transaction amount, the verification module of the point of sale device is configured to verify the transaction data included in the received transaction response, and the memory of the point of sale device is configured to store the verified transaction data.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing offline transactions using local digital currency in accordance with exemplary embodiments.

FIG. 2 is a block diagram illustrating the payment instrument of FIG. 1 for storing and distributing local digital currency for use in processing offline transactions in accordance with exemplary embodiments.

FIG. 3 is a block diagram illustrating the point of sale device of FIG. 1 for processing offline transactions in accordance with exemplary embodiments.

FIGS. 4A and 4B are a flow diagram illustrating a process for processing an offline transaction with a local digital currency in the system of FIG. 1 in accordance with exemplary embodiments.

FIGS. 5 and 6 are flow charts illustrating exemplary methods for processing an offline transaction using local digital currency in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

System for Processing Offline Transactions with a Local Digital Currency

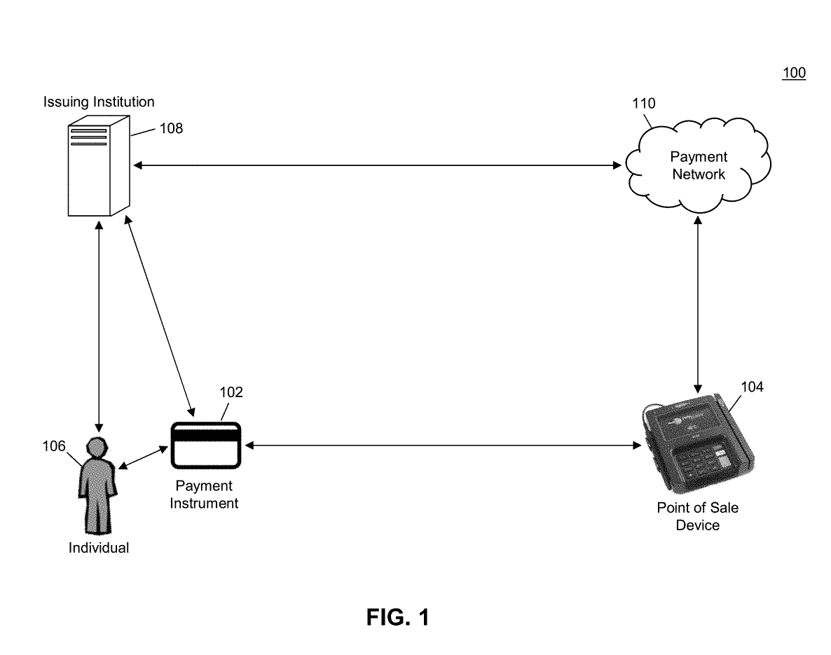

FIG. 1 illustrates a system 100 for the processing of offline transactions at a point of sale via the use of a local digital currency stored in a payment instrument.

The system 100 may include a payment instrument 102. The payment instrument 102, discussed in more detail below, may be configured to locally store a currency limit, which may be used in the processing of payment transactions offline by a point of sale device 104. The payment instrument 102 may be any type of payment instrument configured to store and transmit data, which may be specifically configured to perform the functions discussed herein, such as an integrated circuit payment card, a mobile computing device (e.g., cellular phone, smart phone, tablet computer, wearable computing device, etc.) having an electronic wallet application program, etc.

The payment instrument 102 may be associated with a transaction account. The transaction account may be issued to an individual 106 by an issuing institution 108. The issuing institution 108 may be a financial institution, such as an issuing bank, or other entity configured to issue transaction accounts used to fund electronic payment transactions. The individual 106 may be the holder of the transaction account or an authorized user that is authorized by the issuing institution 108 to use the payment instrument 102 to fund an electronic payment transaction.

In some embodiments, the currency limit stored in the payment instrument 102 may be a credit limit, such as may be associated with the related transaction account (e.g., the credit limit of the transaction account or a portion thereof). In other embodiments, the currency limit may be a limit of digital currency that is stored locally in a memory of the payment instrument 102. The digital currency may be one or more digital values that may be redeemed for fiat currency (e.g., either physical, such as physical cash, or virtual, such as by the addition of funds to a transaction account) by the issuing institution 108 or another suitable financial institution or entity. In some such embodiments, the digital currency may be represented by a memory value. In other such embodiments, the digital currency may be represented by one or more digital certificates.

For example, a digital certificate may represent an amount of digital currency that may be redeemed for the corresponding amount of currency from the issuing institution 108 or another suitable entity. The payment instrument 102 may store one or more digital certificates that may be electronically transmitted to the point of sale device 104 as part of an offline transaction, such that the transmission of the digital certificates may thus transfer the corresponding amount of currency to the point of sale device 104 as payment. In some instances, digital certificates may have different denominations, such that a combination of digital certificates may be transferred to transfer a specified amount of currency. For example, the digital certificates may be stored locally in a payment instrument 102 that correspond to denominations of fiat currency, and may be exchanged between payment instruments 102 and point of sale devices 104 similar to the exchange of fiat currency in a traditional payment transaction.

The individual 106 may present the payment instrument 102 to a point of sale device 104 for the conducting of a payment transaction with a merchant associated therewith. The point of sale device 104 may be notified that the individual 106 is interested in the payment transaction being conducted with a local digital currency of the payment instrument 102. In one embodiment, the indication may be input into the point of sale device 104, such as by the individual 106 or an employee of the merchant. In another embodiment, the point of sale device 104 may receive the notification from the payment instrument 102, such as by reading the notification from the payment instrument 102 (e.g., via a magnetic strip included therein or a machine-readable code displayed thereby), or receiving an electronic transmission from the payment instrument 102 (e.g., via near field communication, an integrated circuit embedded in the payment instrument 102, etc.).

A communication channel may be established between the payment instrument 102 and the point of sale device 104. The communication channel may be established via physical contact, such as by physical contact points of an integrated circuit of the payment instrument 102 and the point of sale device 104, or via wireless communication, such as via a local area network, near field communication, radio frequency, Bluetooth, etc. Transaction data for the payment transaction may be entered into the point of sale device 104, such as a transaction amount, product data, merchant data, reward data, offer data, loyalty data, etc. The point of sale device 104 may electronically transmit the transaction amount, and any other necessary transaction data, to the payment instrument 102 via the established communication channel.

The payment instrument 102 may receive the transaction amount and other transaction data and may verify that the currency limit exceeds the transaction amount. For instance, the payment instrument 102 may ensure that there is a sufficient amount of credit available to cover the transaction amount, or that there is a sufficient amount of stored local digital currency (e.g., in the form of digital certificates) to pay for the transaction amount. Following the verification, the payment instrument 102 may electronically transmit an indication of approval of the payment transaction to the point of sale device 104. In instances where data is used to represent the digital currency, the indication of approval may be accompanied by the data (e.g., digital certificates) corresponding to at least the transaction amount. In instances where the payment instrument 102 may utilize an offline credit limit, the indication of approval may be accompanied by payment credentials associated with the related transaction account, such as a primary account number, one or more payment cryptogram, one or more transaction counters, etc.

The point of sale device 104 may receive the indication of approval and accompanying data via the established communication channel. The point of sale device 104 may then process the payment transaction offline. The offline processing of the payment transaction may include the approval and finalization of the payment transaction without external communication to another entity, such as a payment network 110. In instances where there is a representation of the digital currency provided to the point of sale device 104, the point of sale device 104 may store the data (e.g., digital certificates) locally, which may be redeemed later on for fiat currency or used in future offline payment transactions. In some cases, the corresponding amount of digital currency may be greater than the transaction amount. In such cases, the point of sale device 104 may return additional digital certificates as change to the payment instrument 102 using the established communication channel for storage therein. In some embodiments, the payment instrument 102 or a computing device interfaced therewith may be configured to display the amount of digital currency available via the payment instrument 102 to the individual 106, which may reflect instances where payment is made and change received.

In instances where the payment instrument 102 provides payment credentials to the point of sale device 104, the point of sale device 104 may retain the payment credentials. The point of sale device 104 may then provide the payment credentials to a payment network 110 for processing at a later time, when connection with the payment network 110 (or another entity in communication with the payment network 110) is established. The payment credentials may be provided, along with the additional transaction data for the payment transaction, to the payment network 110 in a transaction message. The transaction message may be generated and submitted directly by the point of sale device 104 to the payment network 110 via payment rails associated therewith, or via one or more intermediate entities, such as an acquiring financial institution (e.g., acquiring bank) or a gateway processor. The payment network 110 may then process the payment transaction using traditional methods and systems, which may include communicating with the issuing institution 108 for approval of the payment transaction as being funded by the corresponding transaction account, where the issuing institution 108 may update a credit limit or balance for the transaction account accordingly.

In such instances, the payment instrument 102 may be configured to update the locally stored currency limit. The payment instrument 102 may also store data related to the electronic payment transaction locally, such as an updated transaction counter or other data. In such cases, the next time the payment instrument 102 is in connection with the issuing institution 108, such as insertion into a point of sale device 104 that is in communication with a payment network 110 connected to the issuing institution 108 or in direct communication with the issuing institution 108 (e.g., an automated teller machine associated with the issuing institution 108), the payment instrument 102 may communicate the updated currency limit and any additional transaction data to the issuing institution 108 for updating of the transaction account accordingly. For example, the issuing institution 108 may update the overall credit limit for the transaction account and may update the currency limit stored in the payment instrument 102 as well as ensure that any transaction counters or cryptograms are updated for use in future offline payment transactions.

In some embodiments, the point of sale device 104 may be configured to authenticate the payment instrument 102 during offline transactions. For instance, the point of sale device 104 may be configured to verify the payment credentials supplied by the payment instrument 102 using known methods. In another example, the point of sale device 104 may prompt the individual 106 to supply a personal identification number, which may be communicated to the payment instrument 102 using the established communication channel for authentication thereof. In yet another example, the individual 106 may provide biometric data (e.g., fingerprint, retinal scan, facial scan, vocal recording, etc.) to the point of sale device 104, which may be communicated to the payment instrument 102 for authentication thereof.

The methods and systems discussed herein may enable an individual 106 to conduct an electronic payment transaction with a point of sale device 104 entirely offline, without an active connection to a payment network 110. The use of a currency limit stored locally in the payment instrument 102 may enable the payment instrument 102 to be used to fund a payment transaction at the point of sale device 104, without requiring external processing. In some cases, a payment instrument 102 may be used indefinitely (e.g., provided sufficient digital currency is stored therein) without being connected to a payment network 110 or issuing institution 108, via the use of a locally stored digital currency.

### Payment Instrument

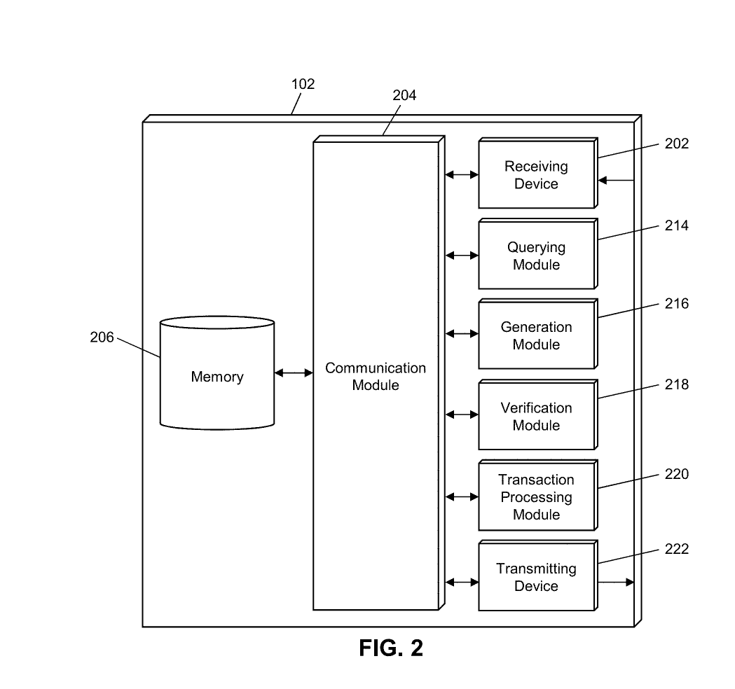

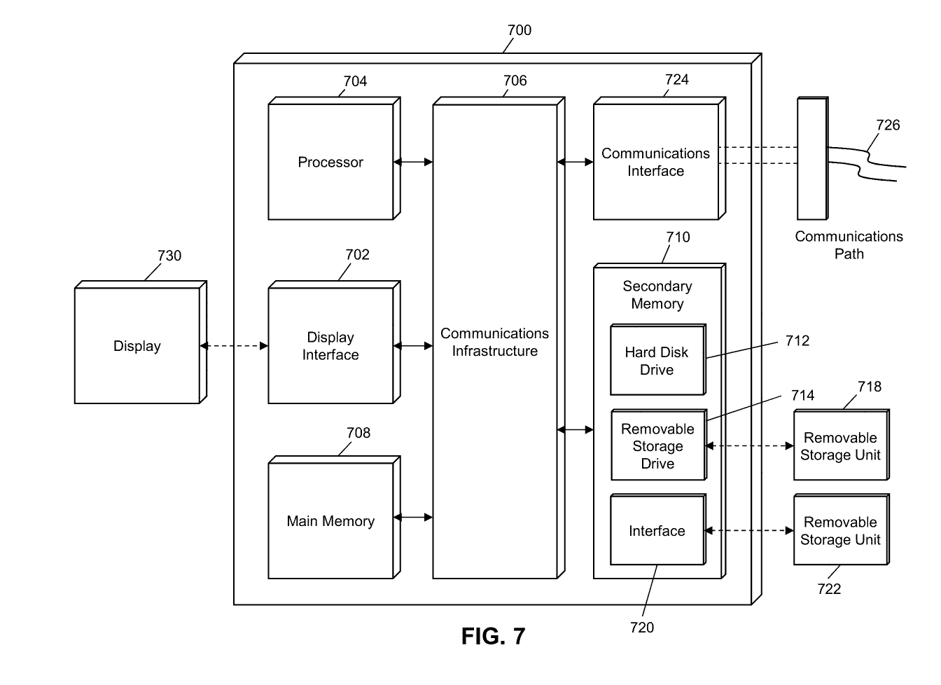

FIG. 2 illustrates an embodiment of a payment instrument 102 in the system 100. It will be apparent to persons having skill in the relevant art that the embodiment of the payment instrument 102 illustrated in FIG. 2 is provided as illustration only and may not be exhaustive to all possible configurations of the payment instrument 102 suitable for performing the functions as discussed herein. For example, the computer system 700 illustrated in FIG. 7 and discussed in more detail below may be a suitable configuration of the payment instrument 102. In an exemplary embodiment, the components of the payment instrument 102 as illustrated in FIG. 2 and discussed herein may be included in an integrated circuit.

The payment instrument 102 may include a receiving device 202. The receiving device 202 may be configured to receive data over one or more networks via one or more network protocols. In some instances, the receiving device 202 may be configured to receive data from issuing institutions 106, point of sale devices 104, and other systems and entities via one or more communication methods, such as near field communication, physical contact points, Bluetooth, etc. In some embodiments, the receiving device 202 may be comprised of multiple devices, such as different receiving devices for receiving data over different networks, such as a first receiving device for receiving data over near field communication and a second receiving device for receiving data via physical contact points. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by point of sale devices 104, which may be superimposed or otherwise encoded with transaction data, such as a transaction amount for an offline electronic payment transaction, or with a transaction confirmation, which may include digital certificates as representation of digital currency, which may be change for the related payment transaction. The receiving device 202 may also be configured to receive data signals electronically transmitted by issuing institutions 108, which may be superimposed or otherwise encoded with a currency limit, which may be a credit limit and accompanied by payment credentials, or may be digital certificates or other data representations of a digital currency.

The payment instrument 102 may also include a communication module 204. The communication module 204 may be configured to transmit data between modules, engines, databases, memories, and other components of the payment instrument 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the payment instrument 102 and external components of the payment instrument 102, such as externally connected databases, display devices, input devices, etc. The payment instrument 102 may also include a processing device. The processing device may be configured to perform the functions of the payment instrument 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, verification module 218, transaction processing module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

The payment instrument 102 may also include a memory 206. The memory 206 may be configured to store data for use by the payment instrument 102 in performing the functions discussed herein, such as public and private keys, symmetric keys, etc. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the payment instrument 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein.

The memory 206 may be configured to store payment credentials for use in the authorization and funding of payment transactions. Payment credentials may include transaction account numbers, names, expiration dates, security codes, transaction counters, cryptograms, etc. The memory 210 may also be configured to store a currency limit. The currency limit may be a credit limit, or may be comprised of one or more digital certificates representative of a digital currency, which may be used in place of a fiat currency in the funding of an electronic payment transaction with the point of sale device 104.

The payment instrument 102 may include a querying module 214. The querying module 214 may be configured to execute queries on databases to identify information. The querying module 214 may receive one or more data values or query strings, and may execute a query string based thereon on an indicated database, such as the memory, to identify information stored therein. The querying module 214 may then output the identified information to an appropriate engine or module of the payment instrument 102 as necessary. The querying module 214 may, for example, execute a query on the memory 206 to identify one or more digital certificates that correspond to a transaction amount received (e.g., via the receiving device 202) from the point of sale device 104, for transmission to the point of sale device 104 for funding of an electronic payment transaction.

The payment instrument 102 may also include a generation module 216. The generation module 216 may be configured to generate data for use in performing the functions of the payment instrument 102 as discussed herein. The generation module 216 may receive instructions as input, which may be used to generate data, and the generated data output to one or more engines or modules of the payment instrument 102. In some instances, the instructions input to the generation module 216 may be accompanied by data for use therewith. For example, the generation module 216 may be configured to generate one or more payment cryptograms for a payment transaction. The generation module 216 may also be configured to generate any other additional data used in the processing and/or authorization of a payment transaction to be funded by the payment instrument 102, such as data messages that are electronically transmitted to the point of sale device 104 via the established communication channel.

The payment instrument 102 may also include a verification module 218. The verification module 218 may be configured to perform verifications for the payment instrument 102 during the performance of the functions discussed herein. The verification module 218 may receive data to be verified as input, may perform the verification, and may output a result of the verification to another module or engine of the payment instrument 102. For example, the verification module 218 may be configured to verify digital certificates received from a point of sale device 104, such as by verifying a digital signature used to sign the digital certificates (e.g., of the issuing institution 108 of the digital certificates) using a suitable method. The verification module 218 may also be configured to verify a personal identification number provided by the point of sale device 104, to verify the individual 106 as an authorized user of the payment instrument 102.

The payment instrument 102 may also include a transaction processing module 220. The transaction processing module 220 may be configured to perform additional functions of the payment instrument 102 related to the processing of payment transactions. For instance, the transaction processing module 220 may be configured to modify transaction counters based on usage of the payment instrument 102, to adjust statistics related to payment transactions stored in the memory 210, to manage the storage and use of payment credentials in the memory 210, to perform checks on personal identification numbers used with the payment instrument 102, etc. Additional functions that may be performed by the transaction processing module 220 will be apparent to persons having skill in the relevant art.

The payment instrument 102 may also include a transmitting device 222. The transmitting device 222 may be configured to transmit data over one or more networks via one or more network protocols. In some instances, the transmitting device 222 may be configured to transmit data to issuing institutions 106, point of sale devices 104, and other entities via one or more communication methods, such as near field communication, physical contact points, Bluetooth, radio frequency, etc. In some embodiments, the transmitting device 222 may be comprised of multiple devices, such as different transmitting devices for transmitting data over different networks, such as a first transmitting device for transmitting data over near field communication and a second transmitting device for transmitting data via physical contact points. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to point of sale devices 104 that are superimposed or otherwise encoded with indications of approval and portions of associated transaction data, which may include payment credentials, digital certificates, or other data associated with a currency limit. In some embodiments, the transmitting device 222 may be configured to electronically transmit data signals to point of sale devices 104 that are superimposed or otherwise encoded with requests for offline processing of a payment transaction. The transmitting device 222 may also be configured to electronically transmit data signals to issuing institutions 108, which may be superimposed or otherwise encoded with transaction data for use in synchronizing the payment instrument 102 with the related transaction account, and for requesting updates for a currency limit stored therein.

### Point of Sale Device

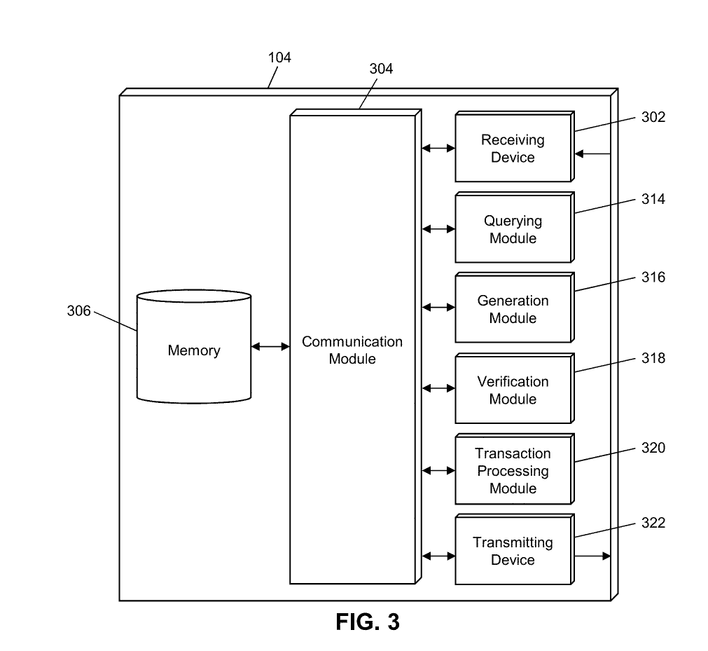

FIG. 2 illustrates an embodiment of a point of sale device 104 in the system 100. It will be apparent to persons having skill in the relevant art that the embodiment of the point of sale device 104 illustrated in FIG. 3 is provided as illustration only and may not be exhaustive to all possible configurations of the point of sale device 104 suitable for performing the functions as discussed herein. For example, the computer system 700 illustrated in FIG. 7 and discussed in more detail below may be a suitable configuration of the point of sale device 104.

The point of sale device 104 may include a receiving device 302. The receiving device 302 may be configured to receive data over one or more networks via one or more network protocols. In some embodiments, the receiving device 302 may be configured to receive data over the payment rails, such as using specially configured infrastructure associated with payment networks 110 for the transmission of transaction messages that include sensitive financial data and information. In some instances, the receiving device 302 may also be configured to receive data from payment cards 102, and other entities via alternative networks, such as the Internet. In some embodiments, the receiving device 302 may be comprised of multiple devices, such as different receiving devices for receiving data over different networks, such as a first receiving device for receiving data over payment rails and a second receiving device for receiving data over the Internet. The receiving device 302 may receive electronically transmitted data signals, where data may be superimposed or otherwise encoded on the data signal and decoded, parsed, read, or otherwise obtained via receipt of the data signal by the receiving device 302. In some instances, the receiving device 302 may include a parsing module for parsing the received data signal to obtain the data superimposed thereon. For example, the receiving device 302 may include a parser program configured to receive and transform the received data signal into usable input for the functions performed by the processing device to carry out the methods and systems described herein.

The receiving device 302 may be configured to receive data signals electronically transmitted by payment cards 102, which may be superimposed or otherwise encoded with indications of approval and associated transaction data, which may include payment credentials or data representative of digital currency, such as one or more digital certificates. The receiving device 302 may also be configured to receive data signals electronically transmitted by payment instruments 102 that may be superimposed or otherwise encoded with requests for transaction data and/or indications that an offline payment transaction is requested. The receiving device 302 may also be configured to receive data signals electronically transmitted by payment networks 110, which may be superimposed or otherwise encoded with data associated with the processing of a payment transaction, such as authorization responses.

The point of sale device 104 may also include a communication module 304. The communication module 304 may be configured to transmit data between modules, engines, databases, memories, and other components of the point of sale device 104 for use in performing the functions discussed herein. The communication module 304 may be comprised of one or more communication types and utilize various communication methods for communications within a computing device. For example, the communication module 304 may be comprised of a bus, contact pin connectors, wires, etc. In some embodiments, the communication module 204 may also be configured to communicate between internal components of the point of sale device 104 and external components of the point of sale device 104, such as externally connected databases, display devices, input devices, etc. The point of sale device 104 may also include a processing device. The processing device may be configured to perform the functions of the point of sale device 104 discussed herein as will be apparent to persons having skill in the relevant art. In some embodiments, the processing device may include and/or be comprised of a plurality of engines and/or modules specially configured to perform one or more functions of the processing device, such as a querying module 314, generation module 316, verification module 318, transaction processing module 320, etc. As used herein, the term “module” may be software or hardware particularly programmed to receive an input, perform one or more processes using the input, and provides an output. The input, output, and processes performed by various modules will be apparent to one skilled in the art based upon the present disclosure.

The point of sale device 104 may also include a memory 306. The memory 306 may be configured to store data for use by the point of sale device 104 in performing the functions discussed herein, such as public and private keys, symmetric keys, etc. The memory 306 may be configured to store data using suitable data formatting methods and schema and may be any suitable type of memory, such as read-only memory, random access memory, etc. The memory 306 may include, for example, encryption keys and algorithms, communication protocols and standards, data formatting standards and protocols, program code for modules and application programs of the processing device, and other data that may be suitable for use by the point of sale device 104 in the performance of the functions disclosed herein as will be apparent to persons having skill in the relevant art, such as transaction data for a payment transaction to be processed, including one or more transaction terms for providing to payment cards 102. In some embodiments, the memory 306 may be comprised of or may otherwise include a relational database that utilizes structured query language for the storage, identification, modifying, updating, accessing, etc. of structured data sets stored therein. The memory 306 may be configured to store transaction data for a payment transaction, and may be further configured to store payment credentials and other data supplied by a payment instrument 102 for later transmission to a payment network 110.

The point of sale device 104 may include a querying module 314. The querying module 314 may be configured to execute queries on databases to identify information. The querying module 314 may receive one or more data values or query strings, and may execute a query string based thereon on an indicated database, such as the memory 306, to identify information stored therein. The querying module 314 may then output the identified information to an appropriate engine or module of the point of sale device 104 as necessary. The querying module 314 may, for example, execute a query on the memory 306 to identify transaction data for a payment transaction, such as a transaction amount, product data, etc.

The point of sale device 104 may also include a generation module 316. The generation module 316 may be configured to generate data for use in performing the functions of the point of sale device 104 as discussed herein. The generation module 316 may receive instructions as input, which may be used to generate data, and the generated data output to one or more engines or modules of the point of sale device 104. In some instances, the instructions input to the generation module 316 may be accompanied by data for use therewith. For example, the generation module 316 may be configured to generate a transaction message for the payment transaction for forwarding to an acquiring institution for submission to the payment network 110, or to generate data for inclusion therein. The generation module 316 may also be configured to generate data for use in payment transactions, such as may be electronically transmitted to the payment instrument 102 for use thereby in performing the functions discussed herein.

The point of sale device 104 may also include a verification module 318. The verification module 318 may be configured to perform verifications for the payment card 102 during the performance of the functions discussed herein. The verification module 318 may receive data to be verified as input, may perform the verification, and may output a result of the verification to another module or engine of the payment card 102. For example, the verification module 318 may be configured to verify digital certificates received from a payment instrument 102, such as by verifying a digital signature used to sign the digital certificates (e.g., of the issuing institution 108 of the digital certificates) using a suitable method. The verification module 318 may also be configured to verify a personal identification number provided by an individual 106 (e.g., via an input device interfaced with the point of sale device 104) to verify the individual 106 as an authorized user of the payment instrument 102.

The point of sale device 104 may also include a transaction processing module 320. The transaction processing module 320 may be configured to perform additional functions of the point of sale device 104 related to the processing of payment transactions. For instance, the transaction processing module 320 may be configured to modify transaction counters based on usage of the point of sale device 104, to adjust statistics related to payment transactions stored in the memory 310, to calculate transaction amounts based on products being purchased, applicable taxes, and other associated fees, to manage the storage and usage of product data, etc. In an exemplary embodiment, the transaction processing module 320 may be configured to process electronic payment transactions offline with suitable payment instruments 102, where the processing may not utilize a payment network 110. Additional functions that may be performed by the transaction processing module 320 will be apparent to persons having skill in the relevant art.

The point of sale device 104 may also include a transmitting device 322. The transmitting device 322 may be configured to transmit data over one or more networks via one or more network protocols. In some embodiments, the transmitting device 322 may be configured to transmit data over the payment rails, such as using specially configured infrastructure associated with payment networks 110 for the transmission of transaction messages that include sensitive financial data and information, such as identified payment credentials. In some instances, the transmitting device 322 may be configured to transmit data to payment cards 102 and other entities via alternative networks, such as the Internet. In some embodiments, the transmitting device 322 may be comprised of multiple devices, such as different transmitting devices for transmitting data over different networks, such as a first transmitting device for transmitting data over the payment rails and a second transmitting device for transmitting data over the Internet. The transmitting device 322 may electronically transmit data signals that have data superimposed that may be parsed by a receiving computing device. In some instances, the transmitting device 322 may include one or more modules for superimposing, encoding, or otherwise formatting data into data signals suitable for transmission.

The transmitting device 322 may be configured to electronically transmit data signals to payment cards 102, which may be superimposed or otherwise encoded with transaction data for a payment transaction, such as a transaction amount to be verified and for the identification of digital certificates corresponding to the transaction amount, or encoded with a personal identification number for verification and authentication of the individual 106. The transmitting device 322 may also be configured to electronically transmit data signals to payment networks 110 using a suitable communication network and method, which may be superimposed or otherwise encoded with transaction data for a payment transaction for processing thereof, including payment credentials, payment cryptograms, etc.

Process for Conducting an Offline Transaction with a Digital Currency

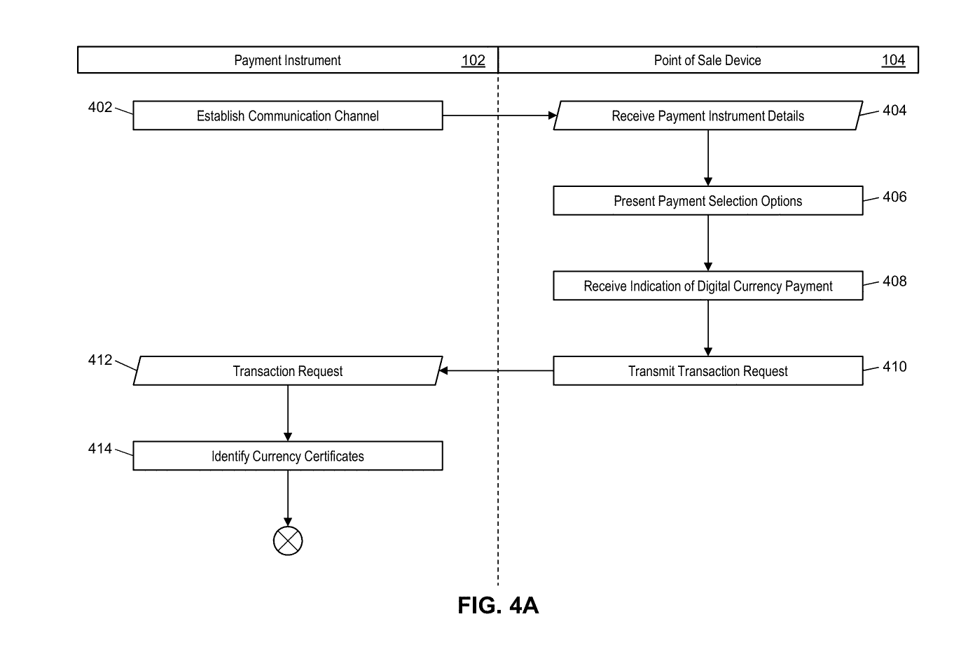

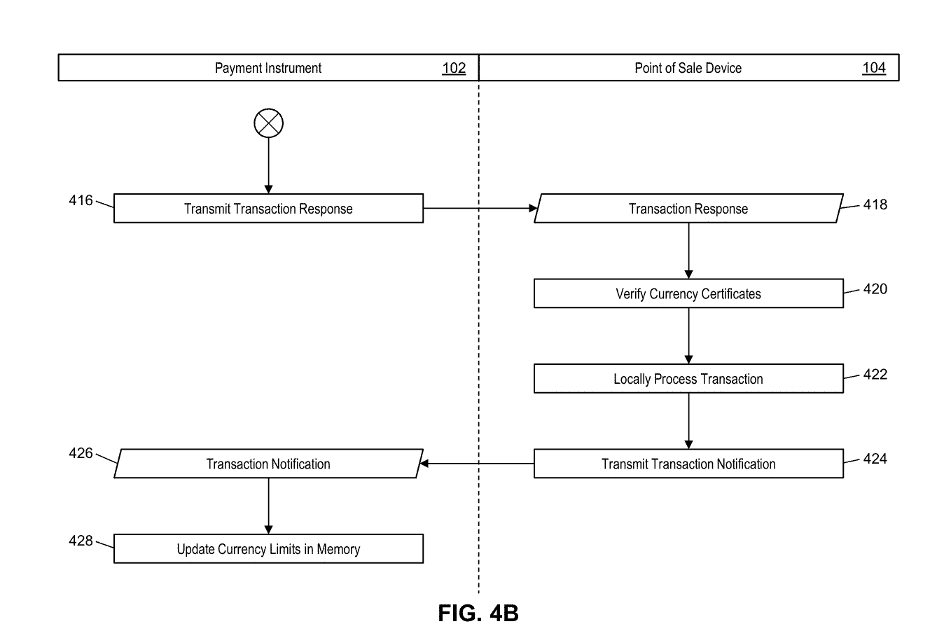

FIGS. 4A and 4B illustrate a process for the conducting of an offline electronic payment transaction in the system 100 of FIG. 1 between the payment instrument 102 and the point of sale device 104 using a digital currency stored locally in the payment instrument 102.

In step 402, the payment instrument 102 may establish a communication channel with the point of sale device 104. The communication channel may be established via a physical connection, such as by insertion of the payment instrument 102 into the point of sale device 104 with physical contact between contact points, or by a non-physical connection, such as a communication channel established via near field communication, Bluetooth, or other suitable communication method. As part of the establishing of the connection, the payment instrument 102 may electronically transmit, via the transmitting device 222 of the payment instrument 102, an indication that it is capable of offline payment transactions using digital currency.

In step 404, the receiving device 302 of the point of sale device 104 may receive the indication from the payment instrument 104 using the established communication channel. In step 406, options for payment may be presented to the individual 106 conducting the payment transaction, such as via a display device interfaced with the point of sale device 104. The options for payment may include an offline electronic payment transaction conducted using digital currency, as well as traditional payment options, such as credit, debit, etc. In step 408, the point of sale device 104 may receive (e.g., via an input device interfaced therewith) an indication that an offline electronic payment transaction conducted using digital currency is desired. For example, the individual 106 may be presented with a button for each payment option and may press the button for the offline, digital currency payment.

In step 410, the transmitting device 322 of the point of sale device 104 may electronically transmit a transaction request to the payment instrument 102 using the established communication channel. The transaction request may be received by the receiving device 202 of the payment instrument 102, in step 412, and may include at least a transaction amount to be paid for the offline electronic payment transaction. In step 414, the querying module 214 of the payment instrument 102 may execute a query on the memory 206 of the payment instrument to identify one or more digital currency certificates stored therein whose cumulative value meets or exceeds the transaction amount.

In step 416, the transmitting device 222 of the payment instrument 102 may electronically transmit a transaction response to the point of sale device 104 using the established communication channel. The transaction response may include at least the identified digital currency certificates, and may include additional information as necessary for the processing of the transaction, such as authentication information (e.g., a personal identification number, transaction counter, etc.). In step 418, the receiving device 302 of the point of sale device 104 may receive the transaction response. In step 420, the verification module 318 of the point of sale device 104 may verify the supplied digital currency certificate(s). Verification of the certificate(s) may include verifying a digital signature of each digital certificate for authentication thereof as genuine, and verification that the value of the digital currency certificate(s) meets or exceeds the transaction amount.

In step 422, the transaction processing module 320 of the point of sale device 104 may process the payment transaction as an offline payment transaction, whereby the processing does not involve the use of a payment network 110. As part of the processing of the payment transaction, the transaction processing module 320 may instruct the querying module 314 of the point of sale device 104 to store the received digital currency certificates in the memory 306 of the point of sale device 104. In cases where the value of the digital currency certificates may exceed the transaction amount, the point of sale device 104 may (e.g., via the querying module 214) identify digital currency certificates whose value is equivalent to the difference.

In step 424, the transmitting device 322 of the point of sale device 104 may electronically transmit a transaction notification to the payment instrument 102 using the established communication channel. In step 426, the receiving device 202 of the point of sale device 104 may receive the transaction notification. The transaction notification may include an indication that the payment transaction was successfully processed, and may also include any digital currency certificates returned by the point of sale device 104 as change for the transaction. In step 428, the querying module 214 of the payment instrument 102 may execute a query on the memory 206 to update the currency limits stored therein, such as to store any additionally received digital currency certificates, and to update any other data as applicable, such as a transaction counter used for authentication.

### First Exemplary Method for Processing an Offline Transaction Using Local Digital Currency

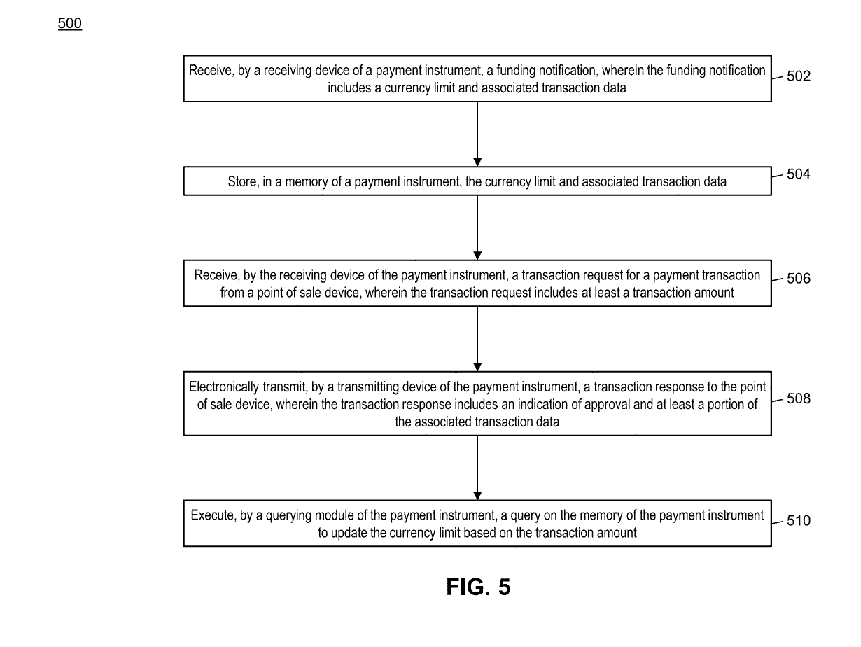

FIG. 5 illustrates a method 500 for the processing of an electronic payment transaction involving a payment instrument without the use of a payment network and using digital currency stored locally in the payment instrument.

In step 502, a funding notification may be received by a receiving device (e.g., the receiving device 202) of a payment instrument (e.g., the payment instrument 102), wherein the funding notification includes a currency limit and associated transaction data. In step 504, the currency limit and associated transaction data may be stored in a memory (e.g., the memory 206) of the payment instrument. In step 506, a transaction request for a payment transaction may be received by the receiving device of the payment transaction from a point of sale device (e.g., the point of sale device 104), wherein the transaction request includes at least a transaction amount.

In step 508, a transaction response may be electronically transmitted to the point of sale device by a transmitting device (e.g., the transmitting device 222) of the payment instrument, wherein the transaction response includes an indication of approval and at least a portion of the associated transaction data. In step 510, a query may be executed on the memory of the payment instrument by a querying module (e.g., the querying module 214) of the payment instrument to update the currency limit based on the transaction amount.

In one embodiment, the associated transaction data may include one or more digital certificates associated with the currency limit, and the portion of the associated transaction data may include at least one digital certificate associated with the transaction amount. In a further embodiment, each digital certificate may include a unique identifier. In some embodiments, the point of sale may be configured to process the payment transaction without the use of a payment network (e.g., the payment network 110). In one embodiment, the payment instrument may be one of: an integrated circuit payment card and a mobile computing device.

### Second Exemplary Method for Processing an Offline Transaction Using Local Digital Currency

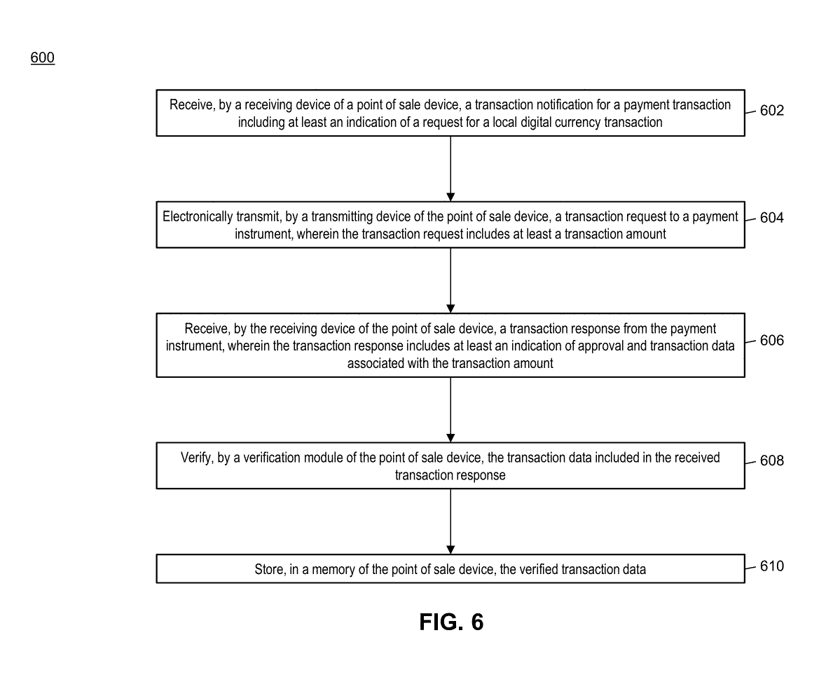

FIG. 6 illustrates a method 600 for the processing of an electronic payment transaction in a point of sale device without the use of a payment network and using digital currency.

In step 602, a transaction notification for a payment transaction may be received by a receiving device (e.g., the receiving device 302) of a point of sale device (e.g., the point of sale device 104), wherein the transaction notification includes at least an indication of a request for a local digital currency transaction. In step 604, a transaction request may be electronically transmitted to a payment instrument (e.g., the payment instrument 102) by a transmitting device (e.g., the transmitting device 322) of the point of sale device, wherein the transaction request includes at least a transaction amount. In step 606, a transaction response may be received by the receiving device of the point of sale device from the payment instrument, wherein the transaction response includes at least an indication of approval and transaction data associated with the transaction amount.

In step 608, the transaction data included in the received transaction response may be verified by a verification module (e.g., the verification module 318) of the point of sale device. In step 610, the verified transaction data may be stored in a memory (e.g., the memory 306) of the point of sale device.

In one embodiment, the transaction data may include one or more digital certificates associated with the transaction amount. In a further embodiment, each digital certificate may include a unique identifier. In some embodiments, the transaction notification may be received from at least one of: the payment instrument and an input device interfaced with the point of sale device. In one embodiment, the point of sale device may be configured to process the payment transaction without the use of a payment network (e.g., the payment network 110).

### Computer System Architecture

FIG. 7 illustrates a computer system 700 in which embodiments of the present disclosure, or portions thereof, may be implemented as computer-readable code. For example, the payment instrument 102 and point of sale device 104 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4A, 4B, 5, and 6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4A, 4B, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for processing offline transactions using local digital currency. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing an offline transaction using local digital currency, comprising:
receiving, by a receiving device of a payment instrument, a funding notification, wherein the funding notification includes a currency limit and associated transaction data;
storing, in a memory of a payment instrument, the currency limit and associated transaction data;
receiving, by the receiving device of the payment instrument, a transaction request for a payment transaction from a point of sale device, wherein the transaction request includes at least a transaction amount;
electronically transmitting, by a transmitting device of the payment instrument, a transaction response to the point of sale device, wherein the transaction response includes an indication of approval and at least a portion of the associated transaction data; and
executing, by a querying module of the payment instrument, a query on the memory of the payment instrument to update the currency limit based on the transaction amount.

2. The method of claim 1, wherein
the associated transaction data includes one or more digital certificates associated with the currency limit, and
the portion of the associated transaction data includes at least one digital certificate associated with the transaction amount.

3. The method of claim 2, wherein each digital certificate includes a unique identifier.

4. The method of claim 1, wherein the point of sale is configured to process the payment transaction without the use of a payment network.

5. The method of claim 1, wherein the payment instrument is one of: an integrated circuit payment card and a mobile computing device.

6. A method for processing an offline transaction using local digital currency, comprising:
receiving, by a receiving device of a point of sale device, a transaction notification for a payment transaction including at least an indication of a request for a local digital currency transaction;
electronically transmitting, by a transmitting device of the point of sale device, a transaction request to a payment instrument, wherein the transaction request includes at least a transaction amount;
receiving, by the receiving device of the point of sale device, a transaction response from the payment instrument, wherein the transaction response includes at least an indication of approval and transaction data associated with the transaction amount;
verifying, by a verification module of the point of sale device, the transaction data included in the received transaction response; and
storing, in a memory of the point of sale device, the verified transaction data.

7. The method of claim 6, wherein the transaction data includes one or more digital certificates associated with the transaction amount.

8. The method of claim 7, wherein each digital certificate includes a unique identifier.

9. The method of claim 6, wherein the transaction notification is received from at least one of: the payment instrument and an input device interfaced with the point of sale device.

10. The method of claim 6, the point of sale is device configured to process the payment transaction without the use of a payment network.

11. A system for processing an offline transaction using local digital currency, comprising:
a transmitting device of a payment instrument;
a querying module of the payment instrument;
a receiving device of the payment instrument, a funding notification, wherein the funding notification includes a currency limit and associated transaction data; and
a memory of a payment instrument configured to store the currency limit and associated transaction data, wherein
the receiving device of the payment instrument is further configured to receive a transaction request for a payment transaction from a point of sale device, wherein the transaction request includes at least a transaction amount;
the transmitting device of the payment instrument is configured to electronically transmit a transaction response to the point of sale device, wherein the transaction response includes an indication of approval and at least a portion of the associated transaction data; and
the querying module of the payment instrument is configured to execute a query on the memory of the payment instrument to update the currency limit based on the transaction amount.

12. The system of claim 11, wherein
the associated transaction data includes one or more digital certificates associated with the currency limit, and
the portion of the associated transaction data includes at least one digital certificate associated with the transaction amount.

13. The system of claim 12, wherein each digital certificate includes a unique identifier.

14. The system of claim 11, wherein the point of sale is configured to process the payment transaction without the use of a payment network.

15. The system of claim 11, wherein the payment instrument is one of: an integrated circuit payment card and a mobile computing device.

16. A system for processing an offline transaction using local digital currency, comprising:
a memory of a payment instrument;
a verification module of the payment instrument;
a receiving device of the payment instrument configured to receive a transaction notification for a payment transaction including at least an indication of a request for a local digital currency transaction; and
a transmitting device of the point of sale device configured to electronically transmit a transaction request to a payment instrument, wherein the transaction request includes at least a transaction amount, wherein
the receiving device of the point of sale device is further configured to receive a transaction response from the payment instrument, wherein the transaction response includes at least an indication of approval and transaction data associated with the transaction amount;
the verification module of the point of sale device is configured to verify the transaction data included in the received transaction response; and
the memory of the point of sale device is configured to store the verified transaction data.

17. The system of claim 16, wherein the transaction data includes one or more digital certificates associated with the transaction amount.

18. The system of claim 17, wherein each digital certificate includes a unique identifier.

19. The system of claim 16, wherein the transaction notification is received from at least one of: the payment instrument and an input device interfaced with the point of sale device.

20. The system of claim 16, the point of sale is device configured to process the payment transaction without the use of a payment network.
